(19) United States
(12) Patent Application Publication
(10) Pub. No.: US 2022/0349326 A1
(43) Pub. Date: Nov. 3, 2022

(54) EXHAUST GAS HEATING ELEMENT

(71) Applicant: FAURECIA SYSTEMES D'ECHAPPEMENT, Nanterre (FR)

(72) Inventors: Thomas FERRIER, MONTBELIARD (FR); Yannick FOURCAUDOT, LUZE (FR); Eric LAMBERT, VALENTIGNEY (FR)

(21) Appl. No.: 17/727,898

(22) Filed: Apr. 25, 2022

(30) Foreign Application Priority Data
Apr. 28, 2021 (FR) 21 04417

(51) Int. Cl. F01N 3/08

(52) U.S. Cl. CPC F01N 3/0892; F01N 2240/16

(57) ABSTRACT

An exhaust gas heating element comprises a wafer that is substantially cylindrical with an axis and is made of metallic foam. A flexible, electrical insulating sheet covers an edge of the wafer with an overlap on each face of the wafer. A rigid assembly ring, a housing, and two electrodes are also provided. The rigid assembly ring is made from a cylinder trunk, at least a first edge of which is serrated in such a way as to be able to immobilize the wafer and the flexible, electrical insulating sheet in the rigid assembly ring by folding teeth, substantially at 90°.

### CROSS-REFERENCE TO RELATED APPLICATIONS

This application is a U.S. non-provisional application claiming the benefit of French Application No. 21 04417, filed on Apr. 28, 2021, which is incorporated herein by reference in its entirety.

### TECHNICAL FIELD

The disclosure relates to an exhaust gas heating element, of the type comprising a metallic foam wafer capable of being heated by Joule effect.

### BACKGROUND

In order to heat an exhaust gas flowing in a pipe, typically located at the exhaust of an internal combustion engine, it is known to use a metallic foam wafer.

The wafer is arranged across the pipe in which the exhaust gas flows, with the axis of the wafer merging with the axis of the pipe.

The porosity of the metal foam makes it possible for the exhaust gas to pass through the wafer. The metallic foam provides the substrate which heats up by Joule effect, by using at least two electrodes, so as to transmit its heat to the exhaust gas passing through the wafer.

However, the metal foam alone lacks mechanical strength and must be reinforced. Furthermore, in order to be able to apply an electric current to the metal foam wafer via electrodes, the wafer must be insulated electrically from the pipe, which is usually metal.

The present disclosure provides a particularly advantageous solution for achieving the functions of stiffening and electrical insulation.

### SUMMARY

The subject disclosure provides an exhaust gas heating element comprising a wafer that is substantially cylindrical with an axis and has a circular, elliptical or rectangular section with rounded corners. The wafer is made of metallic foam and extends perpendicularly to the axis in a large dimension and extends along the axis in a thickness. A flexible electrical insulating sheet covers an edge of the wafer with an overlap on each face of the wafer. A rigid assembly ring is of a same section as the wafer and is substantially cylindrical with the axis The rigid assembly ring covers the sheet with an overlap on each of the faces. A housing is substantially cylindrical with the axis, has a same section as the wafer, and is capable of accommodating the ring and two electrodes. The rigid assembly ring is made from a cylinder trunk of large dimension, of which at least a first edge is serrated so as to be able to immobilize the wafer and the flexible electrical insulating sheet in the rigid assembly ring by folding ring teeth, substantially at 90°.

Particular features or embodiments, usable alone or in combination, include:
a second edge of the rigid assembly ring is serrated in such a way that the wafer and the flexible electrical insulating sheet can be fixed in the rigid assembly ring by folding the second ring teeth, substantially at 90°,
the second edge of the rigid assembly ring is spaced from the first edge of the ring substantially by the thickness plus two overlaps,
a second edge of the rigid assembly ring is die-cut so as to have a reduction in size, similar to that obtained by folding the ring teeth, with a small dimension equal to the large dimension of the wafer minus two overlaps,
the ring teeth have a length substantially equal to the overlap,
a sheet has the shape of a cylinder trunk with a dimension substantially equal to the large dimension, substantially identical to the rigid assembly ring, each of the edges being serrated, in a symmetrical manner, so as to be able to envelop the wafer by folding the sheet teeth substantially at 90°, the sheet teeth having a length substantially equal to the overlap,
a sheet has a flat crown shape, with an inner dimension substantially equal to the small dimension, an outer dimension substantially equal to the inner dimension plus the thickness of the wafer and two overlaps, the outer dimension being serrated so as to be able to envelop the wafer by folding the sheet teeth substantially twice at 90°, the sheet teeth having a length substantially equal to the thickness plus one overlap,
the number of teeth is between 2 and 50, preferably between 4 and 40 and even more preferably between 10 and 30,
the teeth are folded in a radius of between 0.1 and 5 mm, preferably between 0.2 and 2 mm,
the overlap is between 5 and 20 mm, preferably between 8 and 15 mm and even more preferably equal to 11 mm.

### BRIEF DESCRIPTION OF THE DRAWINGS

The disclosure will be better understood upon reading the following description, made only by way of example, and with reference to the appended Figures in which:

FIG. 1 shows a heating element, in an exploded perspective view;

FIG. 2 shows a sub-assembly comprising a ring, a sheet, and a wafer, in a perspective view;

FIG. 3 shows a sub-assembly according to a first embodiment, in a perspective view;

FIG. 4 shows a ring, according to another embodiment, in a perspective view;

FIG. 5 shows a sheet according to another embodiment; and

FIG. 6 shows, a sub-assembly according to another embodiment, in a perspective view.

### DETAILED DESCRIPTION

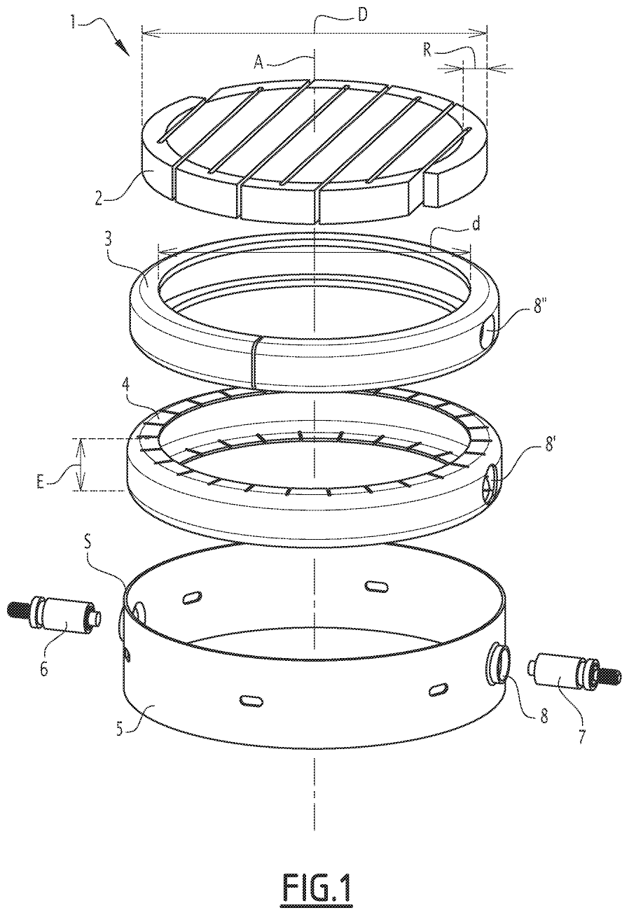

With reference to FIG. 1, a heating element 1 for exhaust gas is shown in an exploded perspective view. This heating element 1 comprises a wafer 2. This wafer 2, of metallic foam, is substantially cylindrical with an axis A, the axis A merging with the axis of the exhaust gas pipe.

A cylinder is understood here and throughout the present document as a general cylinder, i.e. a volume described by translation of any section S along an axis A.

The exhaust gas flow occurs substantially parallel to the direction A.

The wafer 2 has a section S, preferably circular, elliptical, or rectangular, with rounded corners. Also, a main extension of the wafer 2 is perpendicular to the axis A, along a large dimension D. This large dimension D describes the extension of the wafer 2 generically. In the case of an elliptical section, this large dimension D is identified successively with the small or large axis of the ellipse. In the case of a circular section, this large dimension D is identified with the diameter. In the case of a rectangular section, this large dimension D is identified successively with the small or the large side.

The extension of the wafer 2 along the axis A is called a thickness E.

In order to provide electrical insulation around the wafer 2, an insulating sheet 3 covers the wafer 2 in the parts that may be in contact with metal parts: namely, on the edge of the wafer 2. In order to ensure an insulation margin, the sheet 3 is extended by at least one overlap R on each side of the wafer 2. The sheet 3 is made of a flexible textile material and can be shaped by folding. The thickness of the sheet 3 is thin enough to be negligible. Also, the dimension of the sheet 3 in place around the wafer 2 takes up substantially the dimensions of the wafer 2 namely, a general cylinder of large dimension D, section S and thickness E.

A rigid assembly ring 4 surrounds the wafer 2 and sheet 3 assembly, so as to immobilize and hold the sheet 3 in place, while also stiffening the sub-assembly which includes the ring 4, the sheet 3, and the wafer 2. This ring 4 is made of sheet metal. The thickness of the sheet metal is small. Also, the dimension of the ring 4 in place around the sheet 3 and the wafer 2 is substantially the same as the dimensions of the wafer 2: namely a general cylinder of large dimension D, section S and thickness E.

The shape of the ring 4 is substantially identical to that of the sheet 3, in order to substantially cover the latter. The ring 4 has a section S similar to that of the wafer 2, covers the wafer 2 on its edge and has an overlap R on each of the faces of the wafer 2.

The sub-assembly comprising a wafer 2, a sheet 3, and a ring 4 is then arranged in a housing 5, which is housed in the exhaust gas pipe. The latter is substantially cylindrical with axis A and the same section S as the wafer 2.

The assembly is completed by two electrodes 6, 7. The electrodes 6, 7 are preferably arranged radially in holes 8 of the housing 5. These holes 8 correspond to holes 8′ in the ring 4 and holes 8″ in the sheet 3, so that the electrodes 6, 7 can bring the electric current into contact with the wafer 2 in order to heat the wafer 2.

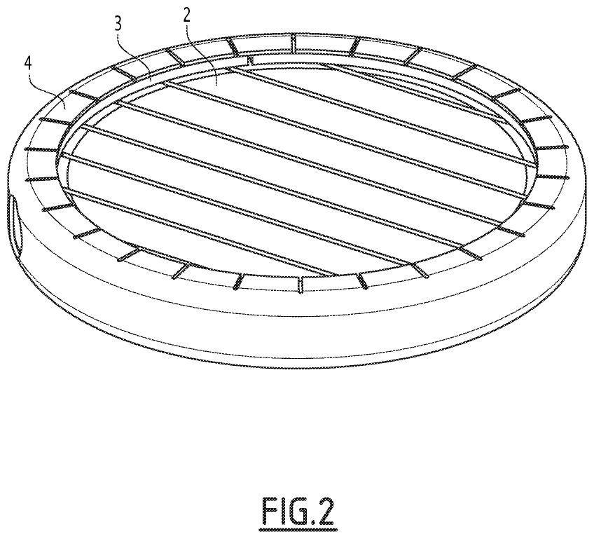

The disclosure focuses on the embodiment of the ring 4 in such a way as to form a subassembly, as illustrated in FIG. 2, comprising a ring 4 clasping a sheet 3 around a wafer 2.

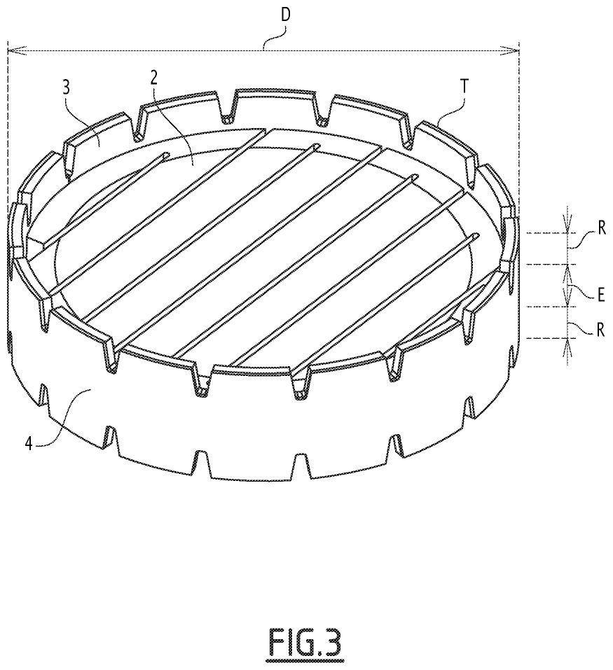

According to a first feature, more particularly illustrated in FIG. 3, the ring 4 is made of a cylinder trunk, here again a general cylinder, of the same section S as the wafer 2, of large dimension D.

According to one advantageous feature, at least a first edge of this cylinder trunk is serrated. Thus, by folding the teeth T substantially at 90°, it is possible to form a stop capable of immobilizing the wafer 2 and the sheet 3 in the ring 4. Folding the teeth T of the upper edge produces a ring 4, as illustrated in FIG. 2.

According to the embodiment shown in FIG. 3, the ring 4 has another second edge of the ring 4, which is also serrated. Thus, according to this embodiment, the ring 4 is symmetrical and the two edges make it possible to form two axial stops, one upper and one lower, suitable for immobilizing the wafer 2 and the sheet 3 in the ring 4, by folding the teeth T substantially at 90°.

In order to be able to clamp a wafer 2 and a sheet 3, as shown in FIG. 3, the height of the cylinder trunk is capable of covering the edge of the wafer 2. Also, this height is equal to the thickness E of the wafer 2. Moreover, this height is extended upwards and downwards by a row of teeth T. The height of a tooth T is equal to an overlap R. Thus, the height of the ring 4 before folding the teeth T is substantially equal to the thickness E of the wafer 2 plus two overlaps R.

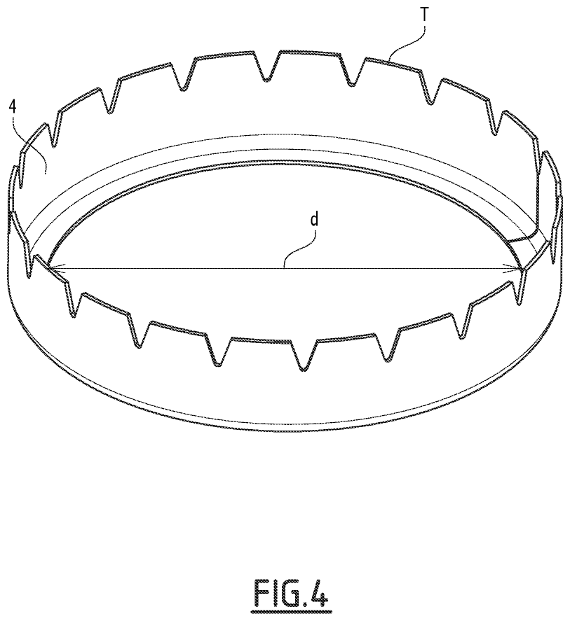

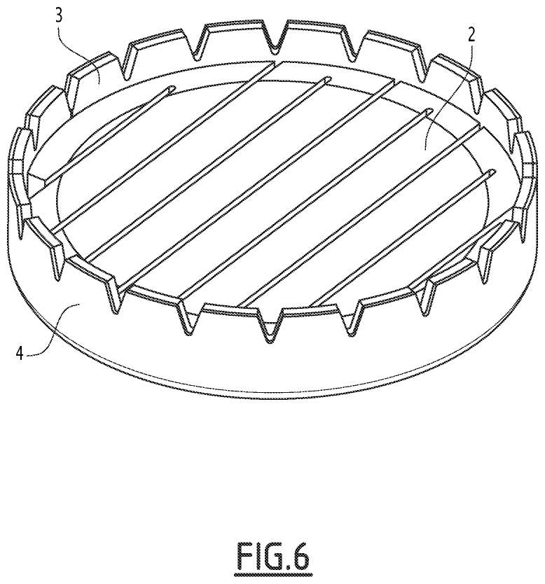

According to another embodiment, more particularly illustrated in FIGS. 4-6, the second edge of the ring 4 is made by die-cutting. As shown in FIG. 4, the object of the die-cutting is to form a stop that has a reduction in size similar to that obtained by folding the teeth T. This stop has a small dimension d equal to the large dimension D of the wafer 2 minus two overlaps R.

This embodiment produces a shape substantially identical to that obtained by folding the teeth T of a serrated edge. However, advantageously, it has better rigidity than its serrated counterpart.

However, only a single edge can be produced by die-cutting.

In both embodiments, at least one edge must be serrated to make it possible to place the wafer 2 and the sheet 3, with the teeth T making closure possible after placement.

According to another feature, the teeth T, both the teeth of the ring 4 and the teeth of the sheet 3, have a length substantially equal to the desired overlap R.

The sheet 3 can be made in at least two embodiments, regardless of the embodiment of the ring 4.

According to another feature, more particularly illustrated in FIG. 3, a sheet 3 is cut in a pattern similar to that of the ring 4 of the first embodiment i.e. a pattern of cylinder trunk shape, of a dimension substantially equal to the large dimension D, each of the edges being serrated in a symmetrical manner in such a way as to be able to envelop the wafer 2 by folding the teeth T, substantially at 90°. In this case, the teeth T have a length substantially equal to the overlap R.

It should be noted that such a sheet 3 is suitable for a ring 4 according to the first embodiment, illustrated in FIG. 3, and is further suitable for a ring 4 according to the second embodiment, illustrated in FIG. 4.

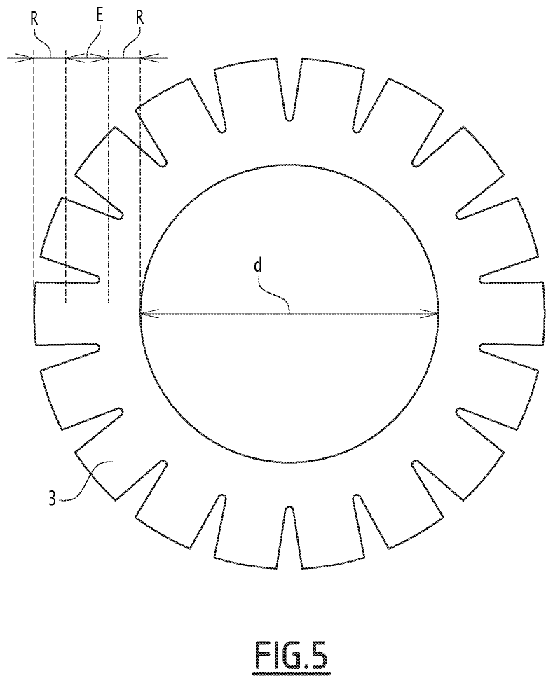

According to another feature, a sheet 3 can still be cut in a pattern as shown in FIG. 5. A sheet 3 then has a flat crown shape. The inner cut has an inner dimension substantially equal to the small dimension d, i.e. a dimension D minus two overlaps R. The outer dimension is substantially equal to the inner dimension plus the thickness E of the wafer 2 and two overlaps R. In addition, the outer contour is serrated in such a way as to be able to envelop the wafer 2 by folding the teeth T, substantially twice at 90°. The plane of the sheet 3 merges here with one side of the wafer 2. Also, the teeth T must be folded a first time to cover the edge of the wafer 2 and a second time to cover the other opposite face of the wafer 2. Also, the teeth T must have an increased length, relative to the other embodiment, i.e. a length substantially equal to the thickness E plus an overlap R.

According to another feature, the number of teeth is between 2 and 50, preferably between 4 and 40 and even more preferably equal to 26.

According to another feature, the teeth T are folded in a folding radius of between 0.1 and 5 mm, preferably between 0.2 and 2 mm. This applies both to the teeth T of the sheet 3 and to the teeth T of the ring 4.

According to another feature, the overlap R is between 5 and 20 mm, preferably between 8 and 15 mm and even more preferably equal to 11 mm.

The disclosure has been illustrated and described in detail in the drawings and the preceding description. The latter should be considered as illustrative and given as an example and not as limiting the disclosure to this description alone. Many variant embodiments are possible.

### LIST OF REFERENCES

1: heating element,
2: wafer,
3: insulating sheet,
4: assembly ring,
5: housing,
6, 7: electrode,
8, 8′, 8″: hole,
A: axis,
D: large dimension,
d: small dimension,
E: thickness,
R: overlap,
S: section,
T: tooth

1. An exhaust gas heating element comprising:
a wafer substantially cylindrical with an axis, the wafer having a section that is circular, elliptical or rectangular with rounded corners, and wherein the wafer is of metallic foam and extends perpendicular to the axis in a large dimension and extends along the axis in a thickness;
a flexible electrically insulating sheet covering an edge of the wafer with an overlap on each face of the wafer;
a rigid assembly ring that is substantially cylindrical and is of a same section as the wafer, wherein the rigid assembly ring covers the edge of the wafer with an overlap on each of the faces of the same section and covers the flexible electrically insulating sheet with an overlap on each of the faces;
a housing substantially cylindrical with the axis and having a same section as the wafer, wherein the housing is configured to accommodate the rigid assembly ring; and
at least two electrodes, wherein the rigid assembly ring is made from a large cylindrical trunk, at least a first edge of which is serrated in such a way as to be able to immobilize the wafer and the flexible electrically insulating sheet in the rigid assembly ring by folding first ring teeth, substantially at 90°.

2. An exhaust gas heating element according to claim 1, wherein a second edge of the rigid assembly ring is serrated in such a way as to be able to immobilize the wafer and the flexible electrically insulating sheet in the rigid assembly ring by folding second ring teeth, substantially at 90°.

3. An exhaust gas heating element according to claim 2, wherein the second edge of the rigid assembly ring is spaced from the first edge of the rigid assembly ring substantially by the thickness plus two overlaps.

4. An exhaust gas heating element according to claim 1, wherein a second edge of the rigid assembly ring is die-cut in such a way as have a reduction in diameter similar to that obtained by folding the first ring teeth, with a small dimension equal to the large dimension of the wafer minus two overlaps.

5. An exhaust gas heating element according to claim 1, wherein the first ring teeth have a length substantially equal to the overlap.

6. An exhaust gas heating element according to claim 1, wherein the flexible electrically insulating sheet has a cylinder trunk shape, substantially equal to the large dimension in size, substantially identical to the rigid assembly ring, each edge of the flexible electrically insulating sheet being symmetrically serrated in such a way as to be able to envelop the wafer by folding sheet teeth substantially at 90°, the sheet teeth having a length substantially equal to the overlap.

7. An exhaust gas heating element according to claim 1, wherein the flexible electrically insulating sheet has a flat crown shape, with an inner dimension substantially equal to a small dimension equal to the large dimension of the wafer minus two overlaps, an outer dimension substantially equal to the inner dimension plus the thickness of the wafer and two overlaps, and the outer dimension being serrated in such a way as to be able to envelop the wafer by folding sheet teeth substantially twice at 90°, the sheet teeth having a length substantially equal to the thickness plus an overlap.

8. An exhaust gas heating element according to claim 1, wherein the number of first ring teeth is between 2 and 50.

9. An exhaust gas heating element according to claim 8, wherein the number of first ring teeth is between 4 and 40.

10. An exhaust gas heating element according to claim 9, wherein the number of first ring teeth is between 10 and 30.

11. An exhaust gas heating element according to claim 1, wherein the first ring teeth are folded at a radius of between 0.1 and 5 mm.

12. An exhaust gas heating element according to claim 11, wherein the first ring teeth are folded at a radius of between 0.2 and 2 mm.

13. An exhaust gas heating element according to claim 1, wherein the overlap is between 5 and 20 mm.

14. An exhaust gas heating element according to claim 13, wherein the overlap is between 8 and 15 mm.

15. An exhaust gas heating element according to claim 14, wherein the overlap is equal to 11 mm.
